(19) United States
(12) Patent Application Publication
(10) Pub. No.: US 2020/0122331 A1
(43) Pub. Date: Apr. 23, 2020

(54) VISUAL ANNOTATIONS IN SIMULATED ROBOT ENVIRONMENTS

(71) Applicant: X Development LLC, Mountain View, CA (US)

(72) Inventors: Anthony Sean Jules, Oakland, CA (US); Johan Ulrich Lewin Jessen, Mountain View, CA (US)

(21) Appl. No.: 14/799,508

(22) Filed: Jul. 14, 2015

(51) Int. Cl. B25J 9/16

(52) U.S. Cl. CPC B25J 9/1682; Y10S 901/47; B25J 9/1697

(57) ABSTRACT

Methods, apparatus, systems, and computer-readable media are provided for visually annotating rendered multi-dimensional representations of robot environments. In various implementations, first and second respective states of an object that exist before and after the object is acted upon by one or more robots may be determined. In various implementations, a multi-dimensional representation of an environment in which the one or more robots operate may be rendered, e.g., as part of a graphical user interface. In various implementations, a graphical representation of the object in at least the first or second state and a visual annotation of a trajectory of the object between the first and second states may be rendered within the multi-dimensional representation of the environment.

### BACKGROUND

Robotic processes may be created and implemented by robots to perform one or more tasks. For example, one robotic process may be implemented by a manufacturing robot to perform one or more steps of an assembly line process. Another robot process may be implemented by an autonomous or semi-autonomous robot to perform a variety of tasks within an environment in response to various triggers. When implementing a robotic process, a robot may act on an object in various ways, such as moving the object, modifying the object, providing the object to another robot, and so forth. When one or more robots are configured to act on large numbers of similar objects, it may be difficult and/or cumbersome using existing techniques to determine information about individual objects before, during, and/or after they are acted upon by the one or more robots.

### SUMMARY

The present disclosure is generally directed to methods, apparatus, and computer-readable media (transitory and non-transitory) for tracking objects acted upon by one or more robots in a robotic environment, and for rendering a multi-dimensional representation of the robotic environment with a variety of visual annotations to demonstrate, in an intuitive manner, how the objects were acted on by the one or more robots. In various implementations, a multi-dimensional (e.g., two-dimensional or three-dimensional) representation of an environment in which one or more robots act upon objects may be rendered. States of objects that are acted upon by the one or more robots (e.g., during simulation or actual robot operation) may be tracked. Various visual annotations may be rendered in the multi-dimensional representation of the environment based on the tracked states and state transitions of the objects resulting from robot action. For example, objects may be annotated differently depending on their state, and trajectories travelled by objects between states may be annotated, e.g., using a visual annotation such as a line or curve that represents the trajectory taken. In this manner, users may be able to visualize how particular objects are acted upon, e.g., for purposes of debugging, object tracking, and/or general understanding.

In some implementations, a computer implemented method may be provided that includes the steps of: determining a first state of an object that exists before the object is acted upon by one or more robots; determining a second state of the object that exists after the object is acted upon by the one or more robots; rendering, as part of a graphical user interface, a multi-dimensional representation of an environment in which the one or more robots operate; and rendering, within the multi-dimensional representation of the environment, a graphical representation of the object in at least the first or second state and a visual annotation of a trajectory of the object between the first and second states.

This method and other implementations of technology disclosed herein may each optionally include one or more of the following features.

In various implementations, rendering the graphical representation of the object in at least the first or second state may include rendering, within the multi-dimensional representation of the environment, a first graphical representation of the object in the first state and a second graphical representation of the object in the second state. In various implementations, the method may further include: rendering a first visual annotation of the first graphical representation; and rendering a second visual annotation of the second graphical representation that is visually distinct from the first visual annotation. In various implementations, one or more of the first graphical representation and the second graphical representation may be rendered in phantom.

In various implementations, the method may further include rendering, within the multi-dimensional representation of the environment, one or more avatars of the one or more robots, wherein the one or more avatars are animated to represent the one or robots acting upon the object. In various implementations, the method may further include detecting, via data received from a user input device, user selection of the graphical representation of the object, wherein rendering the graphical representation of the object and the visual annotation of the trajectory is performed in response to detecting the user selection. In various implementations, the graphical representation of the object and the visual annotation of the trajectory may be rendered simultaneously.

In various implementations, the method may further include: rendering, as part of the graphical user interface, a flowchart representing a robotic process the one or more robots are configured to perform. A plurality of different logical paths through the robotic process may be represented by a plurality of different visible paths through the flowchart. The method may further include determining robot operation data indicative of one or more actual or simulated implementations of the robotic process by the one or more robots; identifying, based on the robot operation data, a first logical path through the robotic process during which the one or more robots act upon the object; selecting a first visible path through the flowchart that corresponds to the identified first logical path; and visually distinguishing the first visible path through the flowchart from a second visible path through the flowchart.

Other implementations may include a non-transitory computer readable storage medium storing instructions executable by a processor to perform a method such as one or more of the methods described above. Yet another implementation may include a control system including memory and one or more processors operable to execute instructions, stored in the memory, to implement one or more modules or engines that, alone or collectively, perform a method such as one or more of the methods described above.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 depicts an example graphical user interface with an “OBJECT TRACKER” dialog, in accordance with various implementations.

FIGS. 2-3 depict example “OBJECT TRACKER” dialogs that may be provided to a user, in accordance with various implementations.

FIG. 4 depicts an example “TRACK OBJECT STATE” dialog that may be provided to a user, in accordance with various implementations.

FIG. 5 depicts an example dialog for presenting a flowchart representing a robotic process, in accordance with various implementations.

FIG. 6 schematically depicts an example environment in which disclosed techniques may be employed, in accordance with various implementations.

FIG. 7 depicts an example method for providing a graphical user interface that includes annotations of object states and transitions, in accordance with various implementations.

FIG. 8 schematically depicts an example architecture of a computer system.

### DETAILED DESCRIPTION

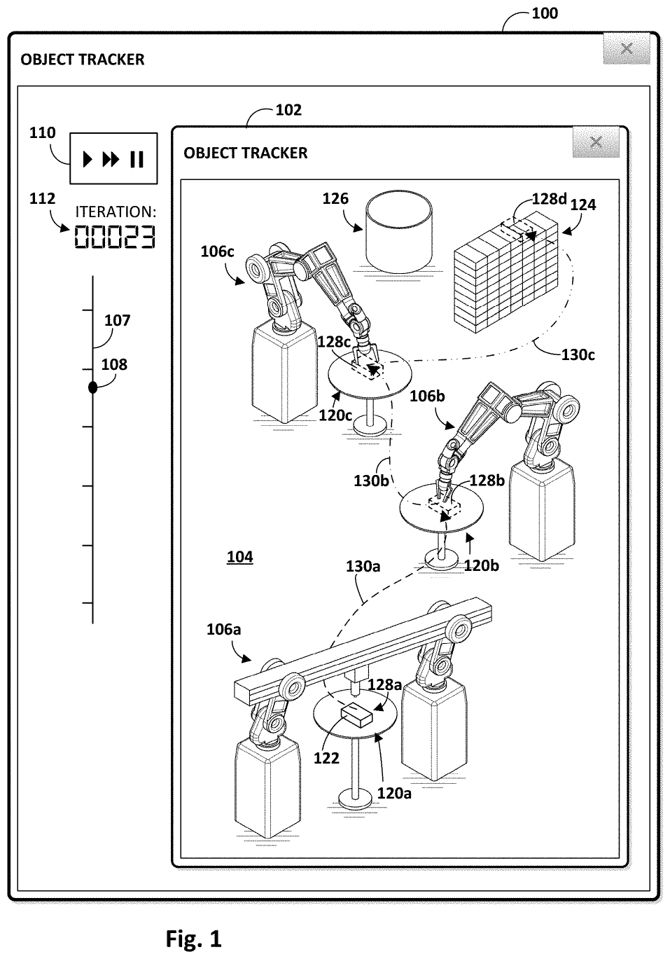

FIG. 1 depicts an example graphical user interface 100 that may be presented to a user, in accordance with various implementations. Graphical user interface 100 may include, e.g., in a first dialog 102, a rendered multi-dimensional representation 104 of an environment (real or simulated) in which one or more avatars 106a-c may represent one or more robots performing one or more robotic processes. In FIGS. 1-4, multi-dimensional representation 104 is three-dimensional. However, this is not meant to be limiting. Techniques disclosed herein are equally applicable in rendered environments having other dimensions, such as two dimensions. While three avatars 106a-c are depicted in FIGS. 1-3 to represent three robots, this is not meant to be limiting. Disclosed techniques may be utilized in any robot environments with any number of robots. Avatars 106a-c may represent real robots performing actual tasks, or may represent real or simulated robots performing simulated tasks.

As used herein, a “robotic process” may refer to a set of instructions that are executable by a robot to perform one or more tasks. These instructions may be implemented in any combination of software (e.g., instructions stored in memory and executable by a processor) and hardware. A plurality of different logical paths may be taken by a robot through a robotic process, depending on various events, decision outcomes (e.g., conditionals), dynamic characteristics of an environment in which a robot operates, and so forth.

In some implementations, graphical user interface 100 may include a timeline 107 with a slider 108 that is movable along timeline 107 in response to various stimuli, such as a user dragging slider 108 along timeline 107, or the passage of time that occurs during implementation of a robotic process. Graphical user interface 100 may further include controls 110. Controls 110 may include various graphical elements (e.g., a “play” button, a “pause” button, a “fast forward” button, a “rewind” button) that may be operable by a user to simulate implementation of one or more robotic processes by avatars 106a-c. An implementations iteration counter 112 may be provided to indicate a number of times a robotic process has been implemented, and/or may be used to identify which implementation of a plurality of consecutive implementations of the robotic process is being demonstrated.

An avatar 106 may resemble any robot that is capable of implementing, and/or has implemented, a robotic process. For example, in FIG. 1, first avatar 106a takes the form of a robot with a horizontal overhanging portion along which an end effector is moveable, and second and third avatars 106b and 106c take the form of robotic arms. However, these examples are for illustrative purposes only, and an avatar 106 may take a variety of other forms as well, including but not limited to animal, insect, aquatic creature, wheeled device, submersible vehicle, unmanned aerial vehicle (“UAV”), and so forth.

In FIG. 1, the three avatars 106a-c are positioned at three respective workspaces, 120a-c. At each workspace 120, the respective avatar 106 may perform a particular task on an object 122. Once an avatar 106 is done performing its respective task on object 122, object 122 may be transported to the next workspace, e.g., by the avatar 106 that just completed its task, by another avatar/robot (not depicted) that is configured to transport objects 122 between workspaces 120, or the next robot to act upon object 122. Assuming all three avatars 106 are able to successfully complete their respective tasks, object 122 may be transported to a first destination 124, which in FIG. 1 is a stack of objects 122. If any of the three avatars 106 are unable to successfully complete their respective tasks, however, then object 122 may be transported to a second destination 126, which in FIG. 1 is a discard bin. Object 122 is depicted in the Figures as a generic cube because object 122 may take any form. Some examples of objects that may be acted upon by robots may include but are not limited to parts (e.g., for vehicles or machines), toys, tools, packages, pallets, appliances, motors, foodstuffs, electronics (e.g., circuit boards, hard drives, i/o devices, smartphones, tablet computers, etc.), and so forth.

A variety of visual annotations may be rendered in multi-dimensional representation 104 to aide a user in tracking how objects 122 are acted upon by avatars 106 (and the robots they represent), as well as determining how individual objects 122 have been acted upon in the past and/or determining how objects 122 will be acted upon in the future. For example, in some implementations, a first state of object 122 that exists prior to object 122 being acted upon by one or more robots (represented by one or more avatars 106) may be determined. A second state of object 122 that exists after object 122 is acted upon by the one or more robots may also be determined. One or more graphical representations 128a-d of object 122 various states, such as the first and second state, may be rendered in multi-dimensional representation 104. In some instances, the graphical representation 128 may be rendered in solid lines (128a), e.g., if the graphical representation represents a current or selected state of object 122. In other instances, the graphical representation 128 may be rendered in phantom (128b and 128c), e.g., to represent past or future states of object 122.

In some implementations, various visual annotations may be rendered on or near graphical representations 128a-d of object 122 to add further explanatory detail. For example, various types of visual emphasis, such as highlighting, conspicuous coloring, animation, or other similar emphasis may be applied to graphical representations 128a-d. Additionally or alternatively, graphical representations 128a-d may be annotated with various text to indicate past, current, or future states.

In some implementations, one or more visual annotations 130 may be rendered in multi-dimensional representation 104 to represent one or more trajectories of object 122 between various states (e.g., first and second states), e.g., to indicate to a user the trajectory followed by object 122 during implementation of the robotic process. In FIG. 1, for instance, three visual annotations, 130a-c, are rendered (e.g., in sequence and/or simultaneously), demonstrating how object 122 travelled from first workspace 120a to second workspace 120b (visual annotation 130a), from second workspace 120b to third workspace 120c (visual annotation 130b), and from third workspace 120c to first destination 124 (visual annotation 130c). Visual annotations 130a-c in combination may visually demonstrate to a user that this particular instance of object 122 was acted upon by all three avatars 106a-c.

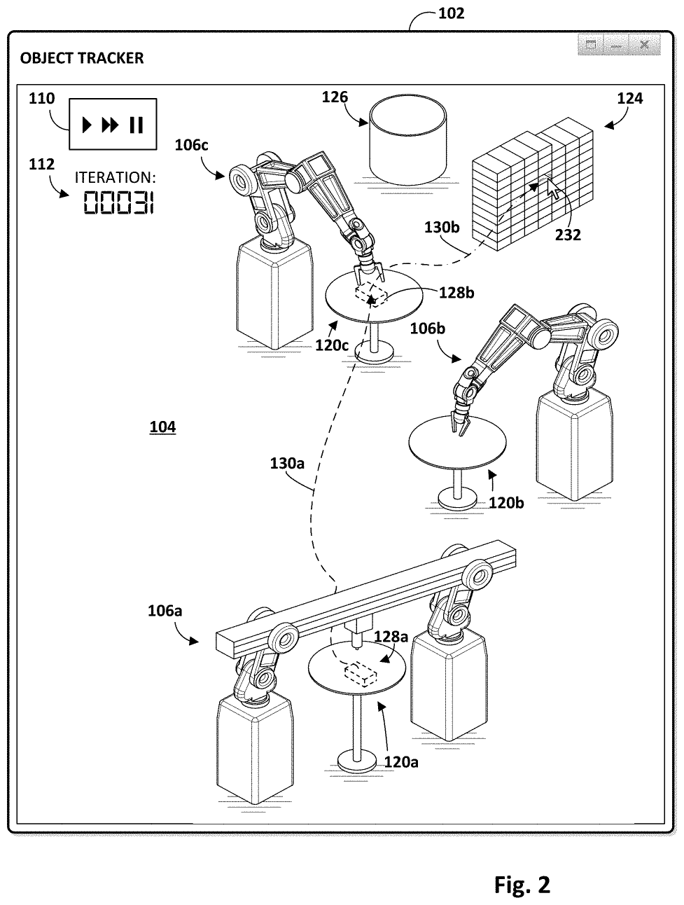

In some implementations, a user may be able to select an object 122 in multi-dimensional environment to learn how the object came to its current state, or how object 122 will be acted upon by robots represented by avatars 106a-c and to which states object 122 will transition. For example, in FIG. 2 (where only first dialog 102 is depicted), an object 122 instance at first destination 124 has been selected as indicated by the cursor 232. The current state of that object 122 is part of the stack of objects at first destination 124. Two visual annotations 130a and 130b, are rendered. Visual annotation 130a demonstrates how the selected object 122 previously passed from first workspace 120a to third workspace 120c, bypassing second workspace 120b (e.g., perhaps the operation to be performed by second avatar 106b was not applicable to this particular instance of object 122). Visual annotation 130b demonstrates how selected object 122 then passes from third workspace 120c to first destination 124. Phantom graphical representations 128a and 128b show object 122 at first workspace 120a and second workspace 120b.

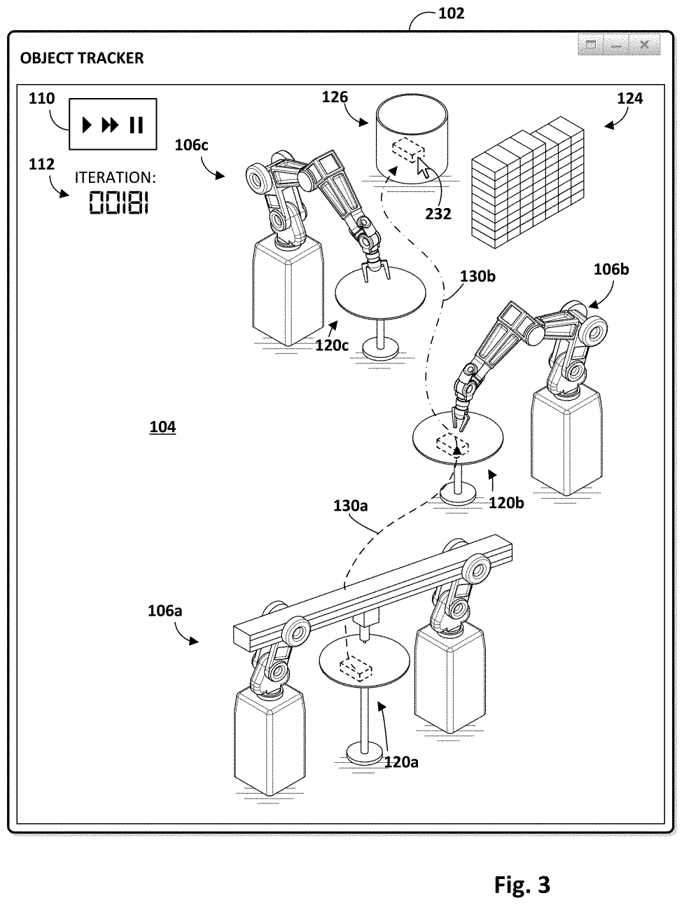

As another example, in FIG. 3, an object at second destination 126 (i.e. discard bin) has been selected using cursor 232. Two visual annotations 130a and 130b, are rendered. Visual annotation 130a demonstrates how the selected object 122 previously passed from first workspace 120a to second workspace 120b. Visual annotation 130b demonstrates how selected object 122 then passes from second workspace 120b to second destination 126 (e.g., perhaps because the robot represented by second avatar 106b determined that the selected object 122 was faulty in some way, and should be discarded).

Some objects that are acted upon by robots, such as rack servers in a server farm, may transition between states without moving. Nonetheless their states may change when acted upon by a robot. Accordingly, in addition to or instead of rendering a visual annotation of a trajectory of an object between states, in various implementations, various states of a stationary object may be conveyed by visually distinguishing the object using one or more visual annotations. Visual annotations that may be used to visually distinguish an object include but are not limited to rendering the object using a particular color, highlighting the object, filling the object with a selected fill pattern, animating the object, rendering the object in phantom (as seen in FIGS. 1-3), rendering the object more brightly than other aspects of a multi-dimensional representation of a robotic environment, overlaying the object with various conspicuous visual annotations (e.g., arrows, words, numbers, emoticons), and so forth.

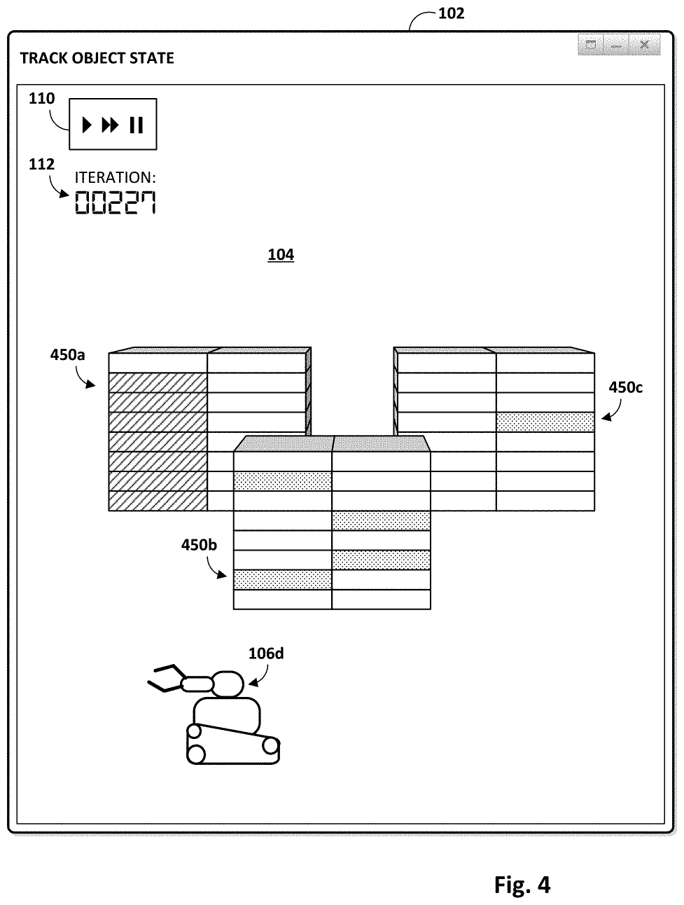

An example of how disclosed techniques may be used to visually annotate stationary objects being acted upon by a robot is depicted in FIG. 4. Three server racks, 450a-c, are depicted, each with two columns of eight servers. An avatar 106d is depicted that represents a robot that may act upon these servers to perform various tasks, such as swapping out hardware components. In this example, nine servers in first server rack 450a are not filled in with any fill pattern. Various servers in the other server racks (450b and 450c) also are not filled in with any fill pattern. This lack of fill pattern may represent a first state in which the servers have not yet been acted upon by a robot represented by avatar 106d. Seven servers in the left column of first server rack 450a are filled in with a first fill pattern to represent a second state in which they have been acted upon by the robot represented by avatar 106d to swap out a first given hardware component, such as a communication interface. Selected servers in second server rack 450b, as well as a single server in third server rack 450c, are filled in with a different fill pattern to represent a third state of being acted upon by the robot represented by avatar 106d. For example, these servers may have had their hard drives swapped out.

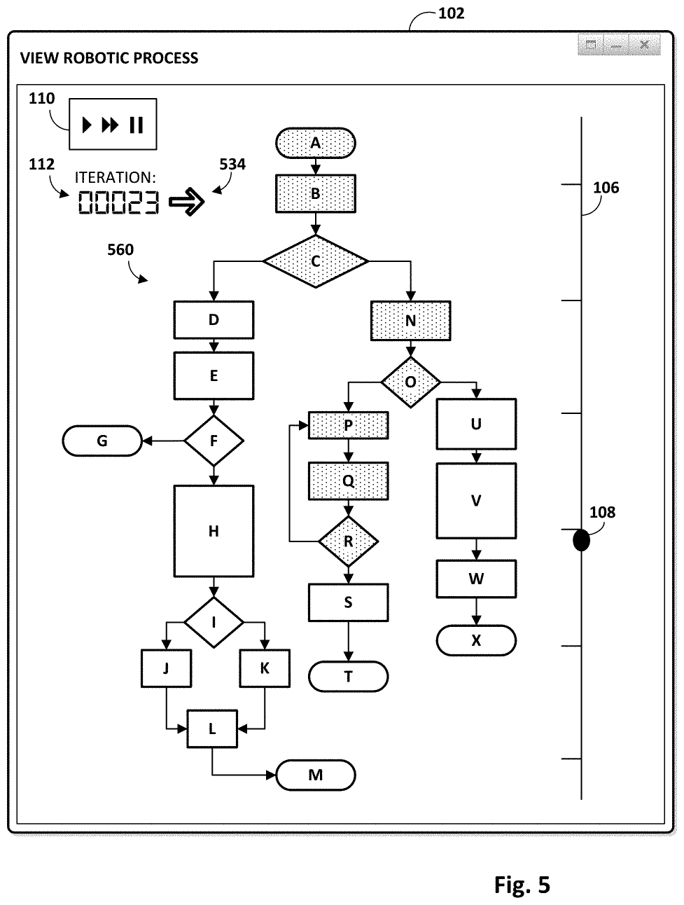

In addition to depicting object states and transitions between object states in multi-dimensional representations of robotic environments, in some implementations, states of objects acted upon by robots may be traced through logical paths of an underlying robotic process. For example, in FIG. 5, dialog 102 includes a flowchart 560 that represents a robotic process implemented by one or more robots while acting on objects. Multiple logical paths of the robotic process may be represented in various implementations by a plurality of different visible paths through flowchart 560. In FIG. 5, flowchart 560 is depicted as being comprised of a plurality of graphical elements A-X connected by a plurality of edges to form a directed graph. However, this is not meant to be limiting, and other types and styles of flowcharts (e.g., state transition charts) may be rendered to represent a robotic process instead.

The rectangular-shaped graphical elements of flowchart 560 (e.g., B, D, E, etc.) may represent operations or actions (e.g., “move,” “grab,” “release,” etc.) performable by a robot during implementation of the robotic process. In some implementations, each rectangular graphical element may represent a so-called “motion primitive,” which may be a generic action performable by a robot. In some instances, a motion primitive may be associated with one or more input parameters that may be provided to dictate how the motion primitive is performed. For example, a motion primitive of “move” may have input parameters such as “velocity,” “compliance,” “distance,” and so forth. The rhombus-shaped graphical elements (e.g., C, F, I, O, etc.) may represent decision points that correspond to, for instance, conditional logic (e.g., if/else statements) present in the robotic process.

Suppose a user has selected a graphical representation of a particular object 122 within an interface such as those depicted in FIGS. 1-4. In various implementations, robot operation data (e.g., run logs) indicative of one or more actual or simulated implementations of the robotic process represented by flowchart 560 during which the selected object was acted upon may be obtained and used to visually distinguish one or more visible paths through flowchart 560 from other visible paths. This visual distinction may aide in object tracking, debugging, and/or otherwise improving the robotic process in various ways. For example, one or more logical paths through the robotic process that resulted in the selected object being acted upon by one or more robots may be identified from robot operation data. One or more visible paths that represent the one or more identified logical paths may then be visually distinguished, e.g., using various visual characteristics, such as color, highlighting, bolding, animation, etc., so that they may be readily identified by the user.

In FIG. 5, implementation iteration counter 112 is set to “00023” to indicate that during the twenty third iteration of the robotic process represented by flowchart 560, the selected object was acted on by one or more robots. A single visible path, A-B-C-N-O-P-Q-R, which corresponds to a logical path taken through the underlying robotic process during the twenty third iteration of the robotic process, has been visually distinguished. Other visible paths through flowchart 560 that correspond to other logical paths through the robotic process, such as A-B-C-D-E-F-H-I-J (or K)-L-M, are not visually distinguished, e.g., because corresponding logical paths through the underlying robot process were not traversed during the twenty third iteration.

In some implementations, the graphical elements of the path A-B-C-N-O-P-Q-R may be visually distinguished sequentially, e.g., in a manner that tracks implementation of the robotic process temporally along timeline 107. For example, slider 108 is at a position along timeline 107 that indicates temporally where simulated implementation of the robotic process (which may have been initiated by pressing the “play” or “FF” buttons of controls 110) currently stands. In some implementations, an avatar 106 (not depicted in FIG. 5, see, e.g., FIGS. 1-4) may be animated simultaneously to simulate implementation of the robotic process by avatar 106, e.g., such that the animation coincides with sequential visual distinction of graphical elements of flowchart 560.

In some instances, there may be multiple iterations of the robotic process during which a selected object was acted upon by one or more robots. Accordingly, in some implementations, a graphical element 534 may be provided to enable a user to toggle through multiple iterations of the robotic process during which the selected object was acted upon by one or more robots. Thus, for example, a user may be able to select an object (e.g., using an interface such as those depicted in FIGS. 1-4) to see multiple iterations during which that object was acted upon by one or more robots. Suppose a selected object was reached during iterations 00023, 00804, and 01003. A user may be able to select a graphical representation of that object, e.g., using one of the interfaces depicted in FIGS. 1-4, (e.g., using a cursor or by operating a touch screen of a smart phone or tablet) and toggle through iterations 00023, 00804, and 01003 using graphical element 534. When the user toggles through each iteration, the graphical elements of the visible path that correspond to the logical path traversed by the one or more robots that acted upon the selected object may be visually distinguished from other visible paths of flowchart 560.

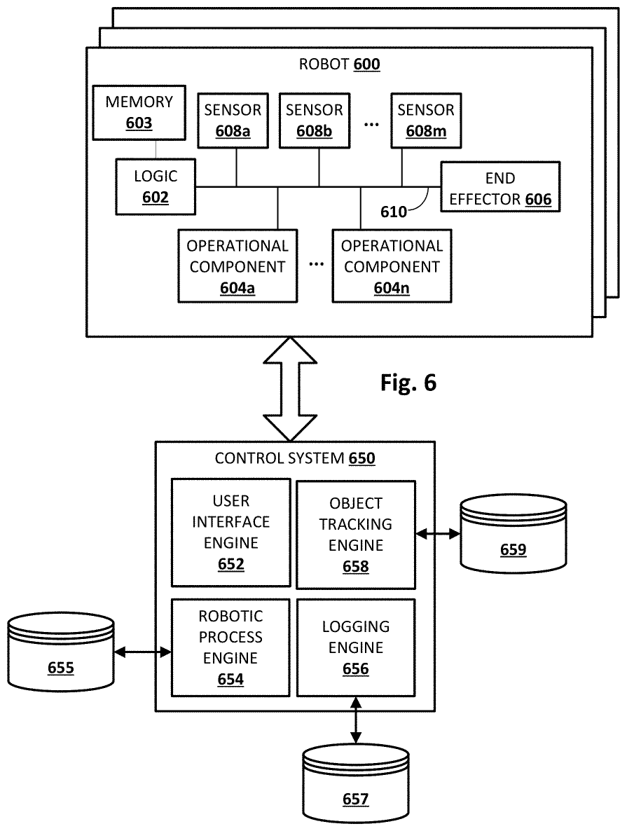

FIG. 6 is a schematic diagram of an example environment in which selected aspects of the present disclosure may be implemented in accordance with various implementations. A robot 600 may be in communication with a control system 650. As noted above, robot 600 may take various forms, including but not limited to a robot arm, a humanoid, an animal, an insect, an aquatic creature, a wheeled device, a submersible vehicle, a UAV, and so forth. In various implementations, robot 600 may include logic 602. Logic 602 may take various forms, such as a real time controller, one or more processors, one or more field-programmable gate arrays (“FPGA”), one or more application-specific integrated circuits (“ASIC”), and so forth. In some implementations, logic 602 may be operably coupled with memory 603. Memory 603 may take various forms, such as random access memory (“RAM”), dynamic RAM (“DRAM”), read-only memory (“ROM”), Magnetoresistive RAM (“MRAM”), resistive RAM (“RRAM”), NAND flash memory, and so forth.

Additionally or alternatively, logic 602 may be operably coupled with one or more operational components 604a-n, one or more end effectors 606, and/or one or more sensors 608a-m, e.g., via one or more buses 610. As used herein, “operational components” 604 of a robot may refer to actuators, motors (e.g., servo motors), joints, shafts, gear trains, pumps (e.g., air or liquid), pistons, drives, or other components that may create and/or undergo propulsion, rotation, and/or motion. Some operational components such as many joints may be independently controllable, although this is not required. In some instances, the more operational components robot 600 has, the more degrees of freedom of movement it may have.

As used herein, “end effector” 606 may refer to a variety of tools that may be operated by robot 600 in order to accomplish various tasks. For example, some robots may be equipped with an end effector 606 that takes the form of a claw with two opposing “fingers” or “digits.” Such as claw is one type of “gripper” known as an “impactive” gripper. Other types of grippers may include but are not limited to “ingressive” (e.g., physically penetrating an object using pins, needles, etc.), “astrictive” (e.g., using suction or vacuum to pick up an object), or “contigutive” (e.g., using surface tension, freezing or adhesive to pick up object). More generally, other types of end effectors may include but are not limited to drills, brushes, force-torque sensors, cutting tools, deburring tools, welding torches, and so forth. In some implementations, end effector 606 may be removable, and various types of modular end effectors may be installed onto robot 600, depending on the circumstances.

Sensors 608 may take various forms, including but not limited to light sensors (e.g., passive infrared), force sensors, pressure sensors, pressure wave sensors (e.g., microphones), proximity sensors (also referred to as “distance sensors”), torque sensors, bar code readers, radio frequency identification (“RFID”) readers, radars, range finders, accelerometers, gyroscopes, compasses, position coordinate sensors (e.g., global positioning system, or “GPS”), speedometers, edge detectors, and so forth. While sensors 608a-m are depicted as being integral with robot 600, this is not meant to be limiting. In some implementations, sensors 608 may be located external to, but may be in direct or indirect communication with, robot 600, e.g., as standalone units or as part of control system 650.

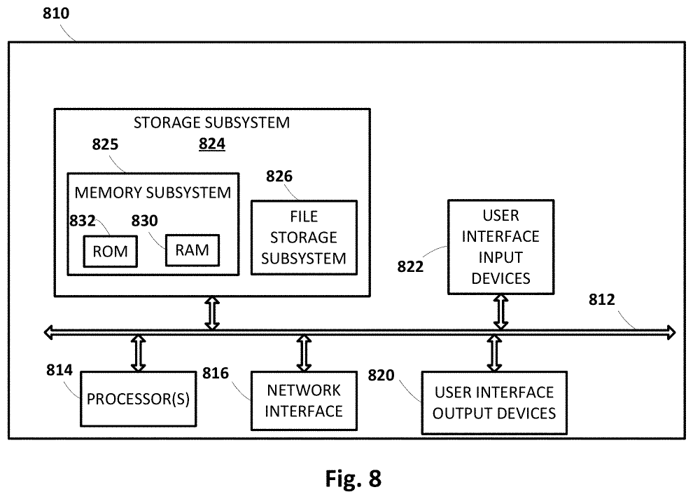

Control system 650 may include one or computing systems connected by one or more networks (not depicted) that control operation of robot 600 to various degrees. An example of such a computing system is depicted schematically in FIG. 8. In some implementations, control system 650 exerts a relatively high level of control over robot 600, e.g., in real time in response to signals received by a user interface engine 652 and/or one or more readings from one or more sensors 608. In other implementations, control system 650 exerts less direct control over robot 600. For example, control system 650 may provide robot 600 with high level tasks and/or actions that form the tasks, data indicative of environmental constraints (e.g., obstacles to avoid), and/or other general constraints that robot 600 may be unable to ascertain itself by processing signals from sensors 608. Logic 602 on robot 600 may convert such high level tasks and actions into robot action, e.g., by translating one or more high level tasks and/or actions into a plurality of motion primitives executable by robot 600. Various modules or engines may be implemented as part of control system 650 as software, hardware, or any combination of the two. For example, in FIG. 6, control system 650 includes the aforementioned user interface engine 652, a robotic process engine 654, a logging engine 656, and an object tracking engine 658.

User interface engine 652 may be configured to enable user input of various commands or tasks for robot 600, and/or output of various data, e.g., to facilitate object tracking and annotation as described herein. In some implementations, user interface engine 652 may provide data usable by a computing device (e.g., laptop, smart phone, workstation, desktop, tablet, etc.) to render the graphical user interfaces and/or dialogs presented in FIGS. 1-5. For example, user interface engine 652 may be configured to obtain, e.g., from robotic process engine 654, data indicative of one or robotic processes (e.g., instruction sets, motion primitives, etc.), and then render one or more flowcharts (e.g., 560) that represent the one or more robotic processes.

Robotic process engine 654 may be operably coupled with an index 655 that contains one or more instruction sets and/or state machines that are configured to cause robot 600 to implement one or more corresponding robotic processes. Robotic process engine 654 may provide data indicative of these one or more robotic processes to other components, such as user interface engine 652, logging engine 656, and/or object tracking engine 658. In some implementations, user interface engine 652 may provide a graphical user interface that enables users to select one or more robotic processes to be simulated, e.g., for object tracking and/or debugging purposes.

Logging engine 656 may be configured to monitor and store, e.g., in index 657, robot operation data indicative of real or simulated robot implementation of the one or more robotic processes stored in index 655. For example, while robot 600 performs an action, sensors 608a-m may output data at various frequencies. At least some of this output sensor data may be captured and logged by logging engine 656. Data that is logged by logging engine 656 is not limited to sensor data. In some implementations, other data pertaining to implementation by robot 600 of a robotic process may also be captured and logged, including but not limited to outcomes (e.g., positive and negative) of implementations of one or more robotic processes, occurrence of errors, occurrence of various user-defined events, and so forth.

Object tracking engine 658 may be configured to track objects through various states and transitions between states as the objects are acted upon by one or more robots, both during actual and simulated robot operation. In various implementations, object tracking engine 658 may store information used to track objects in an index 659. Objects may be identified for tracking purposes before, during, and/or after being acted upon by one or more robots in various ways. To facilitate object identification (and hence, object tracking), objects may include various identification mechanisms, including but are not limited to bar codes, quick response (“QR”) codes, fiducials, etchings, passive and/or active RFID transmitters (e.g., near field communication, or “NFC,” tags) visually identifying attributes of the objects themselves, and so forth.

In some implementations, one or more workspaces may be equipped with mechanisms such as scanners configured to read identification mechanisms associated with objects that are acted upon at the one or more workspaces. In some implementations, human workers may be present to scan objects at and/or between workspaces. In some implementations, one or more sensors 608 of robot 600 itself may be configured to read identification mechanisms associated with objects acted on by robot 600. In various implementations, robot 600 may identify an object before or after robot 600 acts on it (e.g., by scanning a bar code on the object), and then report to object tracking engine 658 that robot 600 encountered the object, and the outcome of robot 600 performing its task on the object (e.g., “success,” “failure,” “pass,” “fail,” etc.). In some implementations, robot 600 may report on a next hop or destination of the object, such as a workspace associated with another robot, or a destination (e.g., 124 or 126 in FIGS. 1-3).

User interface engine 652 may be configured to obtain, from object tracking engine 658, data about past, current, and/or future states of a particular object. User interface engine 652 may then render, e.g., in a multi-dimensional representation (e.g., 104) of a robotic environment, one or more annotations based on the data obtained from object tracking engine 658. These visual annotations may include but are not limited to the visual annotations 130 described above.

User interface engine 652 also may be configured to obtain, e.g., from robotic process engine 654 and/or logging engine 656, robot operation data about a robotic process implemented by robot 600 and/or performance of that robotic process by robot 600. User interface engine 652 may then render, e.g., in the multi-dimensional representation (e.g., 104) of the robotic environment, an avatar (e.g., 106) that represents robot 600. In some implementations, user interface engine 652 may animate the rendered avatar 106 to represent implementation of the robotic process by robot 600. Additionally or alternatively, user interface engine 652 may render a flowchart (e.g., 560) that represents a robotic process, as well as visually distinguish one or more visible paths through that flowchart, as described above with respect to FIG. 5.

While robot 600 and control system 650 are depicted separately in FIG. 6, this is not meant to be limiting. In various implementations, one or more aspects (e.g., modules, engines, etc.) depicted in FIG. 6 as implemented on one of robot 600 or control system 650 may be implemented on the other, may be distributed across both, and/or may be distributed across one or both in combination with other components not depicted in FIG. 6. In implementations where robot 600 and control system 650 are separate, they may communicate over one or more wired or wireless networks (not depicted) or using other wireless technology, such as radio, Bluetooth, infrared, etc. In other implementations, control system 650 may be implemented entirely or in part using logic 602 of robot 600.

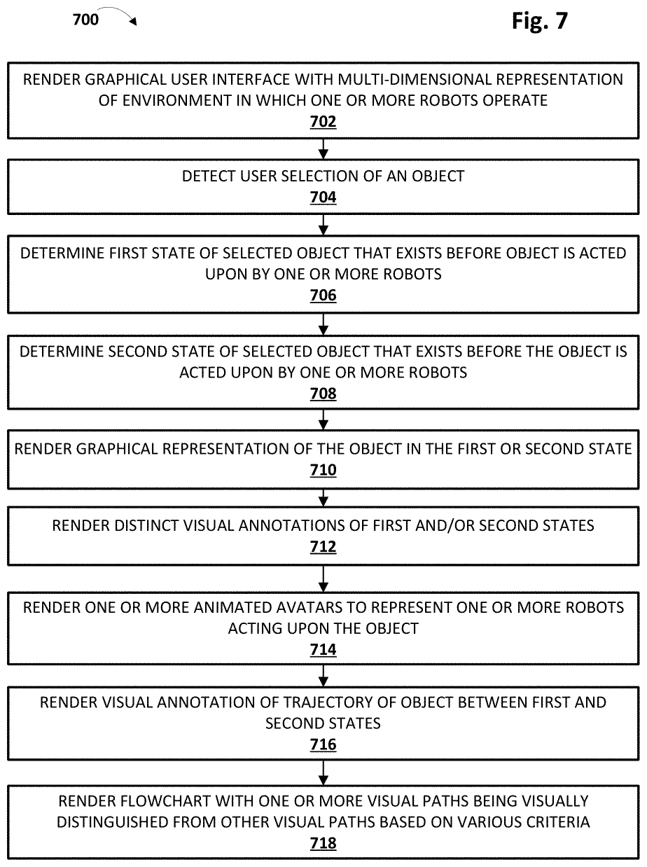

Referring now to FIG. 7, an example method 700 of visually annotating a multi-dimensional representation (e.g., 104) of a robotic environment is described. For convenience, the operations of flow charts are described with reference to a system that performs the operations. This system may include various components of various computer systems, including computing elements of robot 600 and/or control system 650. Moreover, while operations of method 700 are shown in a particular order, this is not meant to be limiting. One or more operations may be reordered, omitted or added.

At block 702, the system may render a graphical user interface with a multi-dimensional representation of an environment in which one or more robots operate. An example of such a multi-dimensional representation is indicated at 104 in FIGS. 1-4. In some implementations, including where robotic operation is simulated rather than actually implemented, the multi-dimensional representation of the environment may be entirely computer-generated. In other implementations, the multidimensional representation may be rendered based on data received via a video feed of an actual robotic environment. Such a video feed may be produced from one or more cameras installed at or near the environment, or even on one or more robots. In such implementations, visual annotations (discussed in more detail above and below) may be overlaid on top of the video feed to achieve what is often referred to as “augmented reality.”

At block 704, the system may detect user selection of an object that has been, is, or will be operated on by one or more robots. For example, objects that may be acted upon by robots that are rendered as part of the multi-dimensional representation at block 702 may be “tagged” or otherwise rendered selectable, so that a user may, for instance, operate a mouse to click on one or more objects. In other implementations, objects may be selected in other ways, such as using drop down menus or other similar user interface elements.

At block 706, the system may determine a first state of a selected object that exists prior to the object being acted on by one or more robots. For example, object tracking engine 658 may consult index 659 for a state of the selected object that existed prior to being acted on by a particular robot. At block 708, the system may determine a second state of the selected object that exists after the object is acted upon by the one or more robots. For example, tracking engine 658 may consult index 659 for a state of the selected object that existed or will exist after being acted on by a particular robot.

At block 710, the system may render a graphical representation of the object in the first state determined at block 706 and/or the second state determined at block 708. For example, if in the first state, the object was located at a first workspace, a graphical representation of the object may be rendered in the multi-dimensional representation at that first workspace. Similarly, if in the second state, the object was located at a second workspace, a graphical representation of the object may be rendered in the multi-dimensional representation at the second workspace.

At optional block 712, the system may render distinct visual annotations representing the first and second states of the object. For example, the graphical representation of the object in its first state at the first workspace may be rendered in one color, and the graphical representation of the object in its second state at the second workspace may be rendered in another color. Or, one graphical representation of the object may be rendered in solid lines or with solid surfaces, and the other may be rendered in phantom, e.g., to demonstrate where the object was previously or where it's going in the future.

At block 714, the system may render one or more avatars (e.g., 106 in FIGS. 1-4) to represent one or more real or simulated robots that operate in the environment. In some implementations, the one or more avatars may be animated to represent the one or more robots acting upon objects. For example, if an object is carried between two workspaces by a robot, an avatar representing that robot may be animated carrying the object from one workspace to the other.

At block 716, the system may render a visual annotation (e.g., 130 in FIGS. 1-3) of a trajectory taken (or to be taken) by an object between states. Visual annotations representing such trajectories may be rendered in various manners, including but not limited to solid lines, dashed lines, animated lines, and so forth. As noted above, multiple visual annotations representing multiple trajectories (e.g., between workspaces) may be rendered separately, e.g., in sequence, and/or simultaneously, e.g., to depict an object's entire path. At block 718, the system may render, e.g., in the same graphical user interface that is used to render the multi-dimensional representation of the environment and the various annotations described above, a flowchart (e.g., 560) that represents an underlying robotic process implemented by one or more robots. In various implementations, such a flowchart may include a plurality of visible paths that correspond to a plurality of logical paths through the underlying robotic process. A given visible path of the multiple visible paths may be visually distinguished from other visible paths of the flowchart based on various criteria. One non-limiting criterion is a logical path corresponding to the given visible path having been traversed when the objected selected at block 704 was acted upon by one or more robots.

FIG. 8 is a block diagram of an example computer system 810. Computer system 810 typically includes at least one processor 814 which communicates with a number of peripheral devices via bus subsystem 812. These peripheral devices may include a storage subsystem 824, including, for example, a memory subsystem 825 and a file storage subsystem 826, user interface output devices 820, user interface input devices 822, and a network interface subsystem 816. The input and output devices allow user interaction with computer system 810. Network interface subsystem 816 provides an interface to outside networks and is coupled to corresponding interface devices in other computer systems.

User interface input devices 822 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 810 or onto a communication network.

User interface output devices 820 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 810 to the user or to another machine or computer system.

Storage subsystem 824 stores programming and data constructs that provide the functionality of some or all of the modules described herein. For example, the storage subsystem 824 may include the logic to perform selected aspects of method 700, and/or to implement one or more aspects of logic 602, user interface engine 652, robotic process engine 654, logging engine 656, and/or object tracking engine 658. Memory 825 used in the storage subsystem 824 can include a number of memories including a main random access memory (RAM) 830 for storage of instructions and data during program execution and a read only memory (ROM) 832 in which fixed instructions are stored. A file storage subsystem 826 can provide persistent storage for program and data files, and may include a hard disk drive, a CD-ROM drive, an optical drive, or removable media cartridges. Modules implementing the functionality of certain implementations may be stored by file storage subsystem 826 in the storage subsystem 824, or in other machines accessible by the processor(s) 814.

Bus subsystem 812 provides a mechanism for letting the various components and subsystems of computer system 810 communicate with each other as intended. Although bus subsystem 812 is shown schematically as a single bus, alternative implementations of the bus subsystem may use multiple busses.

Computer system 810 can be of varying types including a workstation, server, computing cluster, blade server, server farm, smart phone, smart watch, smart glasses, set top box, tablet computer, laptop, or any other data processing system or computing device. Due to the ever-changing nature of computers and networks, the description of computer system 810 depicted in FIG. 8 is intended only as a specific example for purposes of illustrating some implementations. Many other configurations of computer system 810 are possible having more or fewer components than the computer system depicted in FIG. 8.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A method implemented using one or more processors, comprising:
operating one or more robots in an environment to act upon hardware of a plurality of stationary computers, wherein the operating causes robot operation data to be generated;
determining, based on the robot operation data, a first state of a first stationary computer of the plurality of stationary computers that exists before hardware of the first stationary computer is acted upon by one or more of the plurality of robots;
determining, by the one or more processors, based on the robot operation data, a second state of a second stationary computer of the plurality of stationary computers that exists after hardware of the second stationary computer is acted upon by one or more of the robots;
rendering, on a display screen as part of a graphical user interface, a multi-dimensional representation of the environment in which the one or more robots operate; and
simultaneously rendering a plurality of graphical representations corresponding to the plurality of stationary computers, wherein the plurality of graphical representations include first and second graphical representations of the first and second stationary computers in the first and second states, respectively, wherein the first graphical representation is visually distinct from the second graphical representation.

2-3. (canceled)

4. The method of claim 1, wherein one or more of the first graphical representation and the second graphical representation is rendered in phantom.

5. The method of claim 1, further comprising rendering, within the multi-dimensional representation of the environment, one or more avatars of one or more of the robots, wherein the one or more avatars are animated to represent one or more of the robots acting upon the first and second stationary computers.

6-7. (canceled)

8. The method of claim 1, further comprising:
rendering, as part of the graphical user interface, a flowchart representing a robotic process the one or more robots are configured to perform, wherein a plurality of different logical paths through the robotic process are represented by a plurality of different visible paths through the flowchart;
identifying, based on the robot operation data, a first logical path through the robotic process during which one or more of the robots act upon the first or second stationary computer;
selecting, a first visible path through the flowchart that corresponds to the identified first logical path; and
visually distinguishing the first visible path through the flowchart from a second visible path through the flowchart.

9. At least one non-transitory computer-readable medium comprising instructions that, in response to execution of the instructions by the computing system, cause the computing system to perform the following operations:
operating one or more robots in an environment to act upon a hardware of plurality of stationary computers, wherein the operating causes robot operation data to be generated;
determining, based on the robot operation data, a first state of a first stationary computer of the plurality of stationary computers that exists before hardware of the first stationary computer is acted upon by the plurality of robots;
determining a second state of a second stationary computer that will exist in the future after hardware of the second stationary computer is acted upon by the plurality of robots;
rendering, as part of a graphical user interface, a multi-dimensional representation of an environment in which the plurality of robots operate;
simultaneously rendering a plurality of graphical representations corresponding to the plurality of stationary computers, wherein the plurality of graphical representations include first and second graphical representations of the first and second stationary computers in the first and second states, respectively, wherein the first graphical representation is visually distinct from the second graphical representation.

10-12. (canceled)

13. The at least one non-transitory computer-readable medium of claim 9, further comprising instructions for rendering, within the multi-dimensional representation of the environment, one or more avatars of one or more of the robots, wherein the one or more avatars are animated to represent one or more of the robots acting upon the first and second stationary computers.

14. (canceled)

15. The at least one non-transitory computer-readable medium of claim 9, further comprising instructions to perform the following operations:
rendering, as part of the graphical user interface, a flowchart representing a robotic process the one or more robots are configured to perform, wherein a plurality of different logical paths through the robotic process are represented by a plurality of different visible paths through the flowchart;
identifying, based on the robot operation data, a first logical path through the robotic process during which one or more of the robots act upon the object;
selecting a first visible path through the flowchart that corresponds to the identified first logical path; and
visually distinguishing the first visible path through the flowchart from a second visible path through the flowchart.

16. A control system including memory and one or more processors operable to execute instructions stored in the memory, comprising instructions to:
operate a one or more robots in an environment to act upon a plurality of stationary computers, wherein the operating causes robot operation data to be generated;
determine, based on the robot operation data, a first state of a given stationary computer of the plurality of stationary computers objects that exists before the first stationary computer is acted upon by one or more robots;
determine a second state of a second stationary computer that will exist in the future after the second stationary computer is acted upon by the one or more robots;
render, on a display screen as part of a graphical user interface, a multi-dimensional representation of the environment in which the one or more robots operate;
simultaneously render a plurality of graphical representations corresponding to the plurality of stationary computers, wherein the plurality of graphical representations include first and second graphical representations of the first and second stationary computers in the first and second states, respectively, wherein the first graphical representation is visually distinct from the second graphical representation.

17-18. (canceled)

19. The control system of claim 16, wherein one or more of the first graphical representation and the second graphical representation is rendered in phantom.

20. The control system of claim 16, further comprising instructions to render, within the multi-dimensional representation of the environment, one or more avatars of the one or more robots, wherein the one or more avatars are animated to represent one or more of the robots acting upon the first and second stationary computers.
